(19) United States
(12) Patent Application Publication
(10) Pub. No.: US 2023/0018026 A1
(43) Pub. Date: Jan. 19, 2023

(54) SIGNAL PROCESSING SIMULATION METHOD AND SIGNAL PROCESSING SIMULATOR

(71) Applicant: YAMAHA CORPORATION, Hamamatsu-shi (JP)

(72) Inventors: Ayumi FUKATA, Hamamatsu-shi (JP); Kotaro TERADA, Hamamatsu-shi (JP)

(21) Appl. No.: 17/862,720

(22) Filed: Jul. 12, 2022

(30) Foreign Application Priority Data
Jul. 19, 2021 (JP) 2021-118647

(51) Int. Cl. G06F 3/16; H04S 7/00

(52) U.S. Cl. CPC G06F 3/165; H04S 7/30; H04S 2400/01; G06F 3/162

(57) ABSTRACT

A signal processing simulation method includes obtaining a designation of an audio signal processing apparatus that performs first signal processing on a first audio signal input, obtaining a designation of a signal processing component, obtaining settings of the designated signal processing component, and constructing a virtual signal processing device having the designated signal processing component, the constructed virtual processing device corresponding to the designated audio signal processing apparatus. The virtual signal processing device inputs a second audio signal to the designated signal processing component. The designated signal processing component performs second signal processing, according to the obtained settings, on the second audio signal, and outputs the second audio signal on which the second signal processing has performed. The virtual signal processing device includes a logic processor that operates by using the second audio signal inputted to the designated signal processing component as a trigger.

### CROSS REFERENCE TO RELATED APPLICATIONS

This Nonprovisional application claims priority under 35 U.S.C. § 119(a) on Patent Application No. 2021-118647 filed in Japan on Jul. 19, 2021, the entire contents of which are hereby incorporated by reference.

### BACKGROUND

### Technical Field

An embodiment of the present disclosure relates to a signal processing simulation method and a signal processing simulator.

### Background Information

Japanese Unexamined Patent Application Publication No. 2005-318550 discloses that a parameter such as a frequency is changed to a virtual device that has simulated a signal processing component.

Japanese Unexamined Patent Application Publication No. 2015-188203 discloses a DAW (Digital Audio Workstation) as an example in which signal processing is performed on a personal computer.

Japanese Unexamined Patent Application Publication No. 2005-318550 and Japanese Unexamined Patent Application Publication No. 2015-188203, although disclosing that a signal processing component is simulated, do not disclose that a logic processor that operates offline (in a state of being not connected to an audio signal processing apparatus to be simulated) by using an input of an audio signal as a trigger is simulated.

### SUMMARY

In view of the foregoing, an embodiment of the present disclosure is directed to provide a signal processing simulation method in which a logic processor that operates by using an audio signal as a trigger is able to be simulated offline.

A signal processing simulation method includes obtaining a designation of an audio signal processing apparatus that performs first signal processing on a first audio signal input to the audio signal processing apparatus, obtaining a designation of a signal processing component, obtaining settings of the designated signal processing component, and constructing a virtual signal processing device having the designated signal processing component, the constructed virtual processing device corresponding to the designated audio signal processing apparatus.

The virtual signal processing device inputs a second audio signal to the designated signal processing component. The designated signal processing component performs second signal processing, according to the obtained settings of the designated signal processing component, on the second audio signal that has been inputted to the designated signal processing component, and outputs the second audio signal on which the second signal processing has performed. The virtual signal processing device includes a logic processor that operates by using the second audio signal inputted to the designated signal processing component as a trigger.

An embodiment of the present disclosure is able to simulate offline a logic processor that operates by using an audio signal as a trigger.

### BRIEF DESCRIPTION OF THE DRAWINGS

FIG. 1 is a block diagram showing a configuration of an audio signal processing system 1.

FIG. 2 is a block diagram showing a hardware configuration of a processor 11.

FIG. 3 is a block diagram showing a configuration of an information processing apparatus 12.

FIG. 4 is a view showing an example of a GUI that an editor 353 presents.

FIG. 5 is a flow chart showing an operation of the editor 353.

FIG. 6 is a block diagram showing a configuration of an audio signal processing system 1 according to another embodiment.

FIG. 7 is a view showing an example of a GUI that an editor 353 according to a first modification presents.

FIG. 8 is a view showing an example of a GUI that an editor 353 according to a second modification presents.

### DETAILED DESCRIPTION

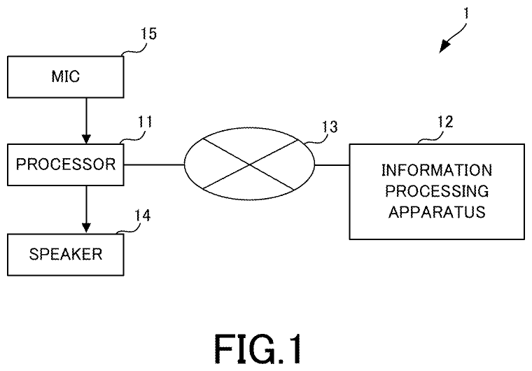

FIG. 1 is a block diagram showing a configuration of an audio signal processing system 1. The audio signal processing system 1 includes a processor 11, an information processing apparatus 12, a network 13, a speaker 14, and a microphone 15.

The processor 11 and the information processing apparatus 12 are connected through the network 13. The network 13 includes a LAN (Local Area Network) or the Internet. The processor 11 is connected to the speaker 14 and the microphone 15 through an audio cable.

However, in the present disclosure, the connection between the devices is not limited to such an example. For example, the processor 11, the speaker 14, and the microphone 15 may be connected through the network. In addition, the processor 11 and the information processing apparatus 12 may be connected by a communication line such as a USB cable.

The processor 11 is an example of the audio signal processing apparatus. The processor 11 receives an audio signal from the microphone 15. In addition, the processor 11 outputs the audio signal to the speaker 14. While the present embodiment shows the speaker 14 and the microphone 15 as an example of an acoustic device to be connected to the processor 11, a greater number of acoustic devices may be further connected.

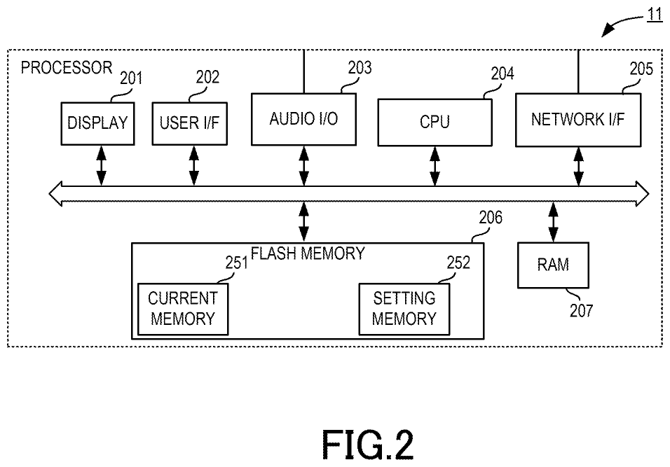

FIG. 2 is a block diagram showing a configuration of the processor 11. The processor 11 includes a display 201, a user I/F 202, an audio I/O (Input/Output) 203, a CPU 204, a network I/F 205, a flash memory 206, and a RAM 207.

The display 201 is mainly made of an LED or an LCD, and displays various types of information (a power ON/OFF state, for example). The user I/F 202 is a physical controller such as a switch or a button. The user I/F 202 takes a user operation such as power ON/OFF.

The CPU 204 functions as a controller to perform system control. The CPU 204 also functions as a signal processor to perform audio signal processing. The CPU 204 reads and executes a predetermined program stored in the flash memory 206 being a storage medium to the RAM 207 and performs operations of a controller and a signal processor.

The CPU 204 performs audio signal processing (first signal processing) such as filter processing on an audio signal (first audio signal) to be inputted from the acoustic device such as the microphone 15 through the audio I/O 203 or the network I/F 205. The CPU 204 outputs the audio signal on which the signal processing has been performed, to an acoustic device such as the speaker 14, through the audio I/O 203 or the network I/F 205.

A parameter that shows content of the audio signal processing is stored in a current memory 251 in the flash memory 206. The CPU 204 performs audio signal processing based on the parameter stored in the current memory 251.

Setting details (setting information) of the system control is stored in a setting memory 252 in the flash memory 206. The CPU 204 performs the system control based on the setting information stored in the setting memory 252. The system control includes patch setting (wire connection management) for an input port (a physical port) to receive an input of the audio signal and an input channel, for example.

It is to be noted that the program that the CPU 204 reads does not need to be stored in the flash memory 206 in the own apparatus. For example, the program may be stored in a storage medium of an external apparatus such as a server. In such a case, the CPU 204 may read out the program each time from the server to the RAM 207 and may execute the program.

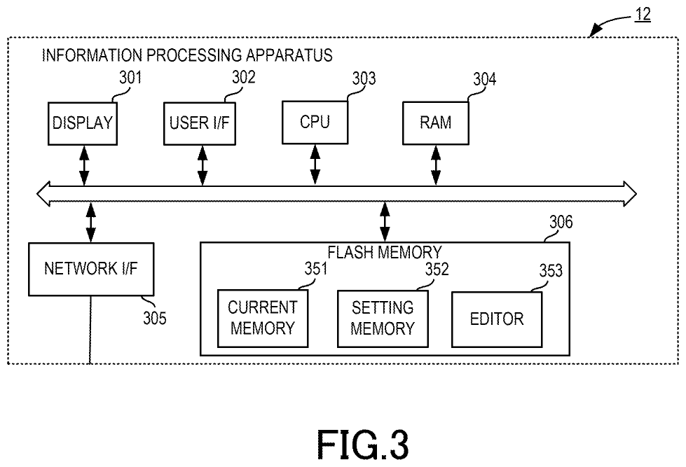

Next, FIG. 3 is a block diagram showing a configuration of the information processing apparatus 12. The information processing apparatuses 12 is an example of a signal processing simulator and may be an information processing apparatus such as a personal computer or a dedicated embedded system, for example. The information processing apparatus 12 may be a cloud server connected to the processor 11 through the Internet.

The information processing apparatus 12 includes a display 301, a user I/F 302, a CPU 303, a RAM 304, a network I/F 305, and a flash memory 306.

The CPU 303 reads out a program stored in the flash memory 306 being a storage medium to the RAM 304 and implements a predetermined function. It is to be noted that the program that the CPU 303 reads out does not also need to be stored in the flash memory 306 in the own apparatus. For example, the program may be stored in a storage medium of an external apparatus such as a server. In such a case, the CPU 303 may read out the program each time from the server to the RAM 304 and may execute the program.

The flash memory 306 includes a current memory 351, a setting memory 352, and an editor 353. The current memory 351 is synchronized with the current memory 251 of the processor 11. In addition, the setting memory 352 is synchronized with the setting memory 252 of the processor 11.

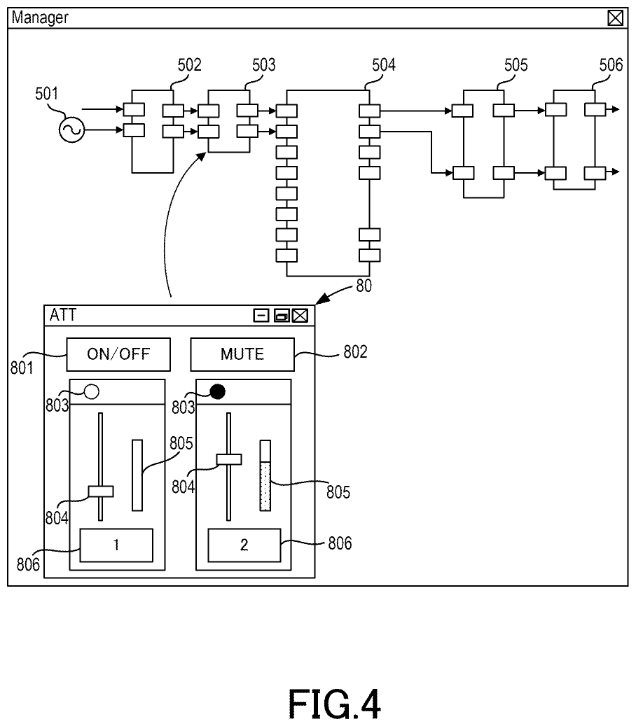

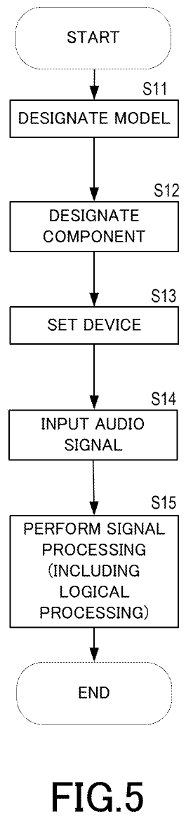

The editor 353 is a program that simulates the audio signal processing apparatus such as the processor 11. FIG. 4 is a view showing an example of a GUI that the editor 353 presents, and FIG. 5 is a flow chart showing an operation of the editor 353. The CPU 303 reads out the editor 353 to the RAM 304 and performs the following operations.

First, the editor 353 takes designation of a model of the audio signal processing apparatus to be simulated (S11). The model includes, for example, a type and a model name of the audio signal processing apparatus. In this example, the editor 353 takes the model name of the processor 11. Subsequently, the editor 353 takes designation of a signal processing component in the audio signal processing apparatus of a designated model (S12). The signal processing component means a functional configuration including receiving an input of an audio signal, performing predetermined signal processing on the audio signal that has been inputted, and outputting the audio signal. The signal processing component, as shown, for example, in FIG. 4, includes an effect processor such as an attenuator (ATT), a mixing component that performs mixing (Mix) processing, and an amplifier (Amp) that performs amplification processing of an audio signal. A user, by placing an icon image of a signal processing component at any position on a GUI screen as shown in FIG. 4, designates a signal processing component to use.

Then, the editor 353 takes settings of a signal processing device constructed by a designated signal processing component (S13). For example, the user, by performing operation of mutually connecting a plurality of signal processing components placed on the GUI screen as shown in FIG. 4, sets a parameter to each signal processing component. Accordingly, the signal processing device is set. In the example of FIG. 4, the user designates an oscillator 501, an input component 502, an attenuator 503, a mixing component 504, an amplifier 505, and an output component 506.

The input component 502 corresponds to a plurality of input ports (an analog input port or a digital input port, for example) in the audio I/O 203. The input component 502 assigns at least one port among the plurality of input ports to at least one channel of a plurality of input channels.

The attenuator 503 is an example of the effect processor. The attenuator 503 performs signal processing to attenuate an inputted audio signal. The mixing component 504 performs signal processing to mix an audio signal of each input channel to any output channel. The amplifier 505 performs signal processing to amplify the audio signal of each output channel. The output component 506 assigns each output channel to any one port among a plurality of output ports.

The user, by mutually connecting each signal processing component along a flow of the audio signal, constructs the flow of the signal processing. Then, the user sets a parameter of each signal processing component. For example, when the user selects the icon image of each signal processing component, the editor 353 presents a parameter setting screen of a corresponding signal processing component. In the example of FIG. 4, the editor 353 takes a selection of the attenuator 503 and presents the parameter setting screen 80 of the attenuator 503.

The parameter setting screen 80 of the attenuator 503 includes an ON/OFF button 801, a mute button 802, an LED 803, a slider 804, a meter 805, and a channel name display 806. The LED 803, the slider 804, the meter 805, and the channel name display 806 are provided for each channel.

The ON/OFF button 801 is a parameter that indicates whether to enable or disable the signal processing of the attenuator 503. The mute button 802 is a parameter that indicates whether to block an audio signal. The LED 803, in a case in which the attenuator 503 receives an input of an audio signal, is turned on, and, in a case in which the attenuator 503 receives no input of an audio signal, is turned off. The LED 803 is an example of a logic processor that operates by using the audio signal as a trigger. The meter 805 shows a level of the audio signal inputted to the attenuator 503. The meter 805 is also an example of the logic processor that operates by using the audio signal as a trigger. The channel name display 806 displays a channel name.

The signal processing component that starts processing in a case in which the level of the inputted audio signal is not less than a predetermined value or not more than a predetermined value is also an example of the logic processor that operates by using the audio signal as a trigger. For example, a noise gate, in a case in which the level of the inputted audio signal is not more than a predetermined value, becomes muted and, in a case in which the level of the inputted audio signal exceeds a predetermined value, causes the audio signal to pass as it is. In addition, for example, a compressor, in a case in which the level of the inputted audio signal is not less than a predetermined value, reduces the level of the audio signal to be outputted with respect to the inputted audio signal. These noise gate and compressor are also examples of the logic processor that operates by using the audio signal as a trigger.

In addition, for example, an RMS meter that shows an average of the level of the audio signal within a predetermined time is also an example of the logic processor that operates by using the audio signal as a trigger. The signal processing component that performs automatic volume control is also an example of the logic processor that operates by using the audio signal as a trigger. The signal processing component, in a case in which the average of the level of the audio signal within a predetermined time is not more than a predetermined value, performs automatic volume control to increase sound pressure only by a predetermined value.

In addition, the LED 803 may be connected to a plurality of signal components and set a logical circuit to the input of an audio signal. For example, the LED 803, in a case of setting an AND circuit, is turned on only in a case in which the audio signal is inputted to all target signal processing components. The LED 803, in a case of setting an OR circuit, is turned on in a case in which the audio signal is inputted to at least one signal processing component among the target signal processing components. In addition, the LED 803 is also able to use a logical circuit such as NOT, NAND, NOR, XOR, or XNOR, in addition to the AND circuit and the OR circuit.

The logic processor is not limited only to lighting and may output an OFF value (0) or an ON value (1). In addition, the logic processor may perform different operation according to the level of the audio signal. For example, the LED 803 may be turned blue in a case in which the level of the inputted audio signal is more than −80 dB and not more than −60 dB, may be turned green in a case in which the level of the inputted audio signal is more than −60 dB and not more than −40 dB, may be turned orange in a case in which the level of the inputted audio signal is more than −40 dB and not more than −20 dB, and may be turned red in a case in which the level of the inputted audio signal is more than −20 dB. The user, by operating the ON/OFF button 801, the mute button 802, and the slider 804, sets the parameter of the attenuator 503.

The CPU 303 updates the current memory 351 and the setting memory 352 with the signal processing component designated by the editor 353 and each set parameter.

The CPU 303, in a state (an online state) of connecting to the processor 11, sends the content of the updated current memory 351 and setting memory 352, to the processor 11. The CPU 204 of the processor 11 receives the content of the updated current memory 351 and setting memory 352, and synchronizes the content of the current memory 251 and the setting memory 252 with the content of the updated current memory 351 and setting memory 352. The processor 11 performs signal processing according to the content of the current memory 351 and the setting memory 352 on the audio signal inputted from an acoustic device such as the microphone 15, and outputs the audio signal on which the signal processing has been performed, to an acoustic device such as the speaker 14.

As a result, the information processing apparatus 12, in a case of being in an online state of being connected to the processor 11, is able to control the content of the signal processing of the processor 11.

On the other hand, the processor 11 and the information processing apparatus 12, in a case of a mutually non-connected state (an offline state), independently change the content of each of the current memory and the setting memory. In other words, the CPU 303 of the information processing apparatus 12 constructs the virtual signal processing device corresponding to the signal processing device taken by the editor 353 in the information processing apparatus 12, and is able to simulate audio signal processing independently of the processor 11.

In the offline state, each signal processing component is a virtual signal processing component obtained by simulating the signal processing component in the processor 11. The CPU 303 inputs an audio signal (second audio signal) to each virtual signal processing component (S14). For example, in FIG. 4, the oscillator 501 is connected to a second port of the input component 502. The CPU 303 causes the audio signal to be outputted from the oscillator 501, and inputs the audio signal to a corresponding virtual signal processing component.

Each virtual signal processing component, according to the current memory 351 and the setting memory 352, performs predetermined signal processing (second signal processing) on the audio signal that has been inputted, and outputs the audio signal on which the signal processing has performed (S15). In the example of FIG. 4, the audio signal is inputted from the oscillator 501 to the second port of the input component 502. In addition, the input component 502 inputs the audio signal to a second input channel. The attenuator 503 receives an input of the audio signal in a second channel, and performs attenuation processing on the audio signal at a level set by the slider 804. In addition, the attenuator 503 lights the LED 803 and also performs logic processing that drives the meter 805 according to the level of the audio signal that has been inputted. In the example of FIG. 4, the audio signal is inputted to the second input channel. Therefore, the attenuator 503 lights the LED 803 of the second input channel, and drives the meter 805 according to the level of the audio signal inputted to the second input channel.

Therefore, the information processing apparatus 12, even in the offline state, is able to simulate the signal processing to be performed by the processor 11. In particular, the information processing apparatus 12 is also able to simulate offline a logic processor that operates by using an input of the audio signal as a trigger.

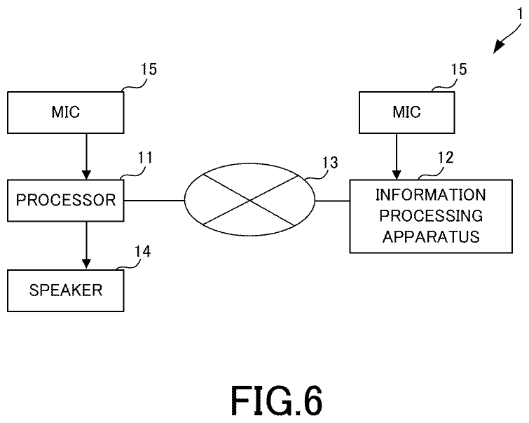

In the example of FIG. 4, the CPU 303 causes the audio signal to be outputted from the oscillator 501, and inputs the audio signal to a corresponding virtual signal processing component. However, the information processing apparatus 12, as shown in FIG. 6, as with the processor 11, may receive an input of the audio signal from an acoustic device such as the microphone 15. In such a case, the signal processing component of the oscillator 501 is unnecessary. However, when the oscillator 501 outputs a simple sound such as a sine wave, each signal processing component is able to simulate signal processing with a lower load than a load of the signal processing to be actually performed by the processor 11. In particular, the logic processor that operates by using the input of the audio signal as a trigger is still able to check an operation even when a sound is different from a sound (such as a sound inputted from a microphone connected to the information processing apparatus 12 or a sound that the oscillator 501 outputs) to be inputted to the processor 11.

The information processing apparatus 12 does not need to perform signal processing in the same amount of time as the audio signal processing apparatus (the processor 11, for example) to be simulated. In other words, a first time from when the virtual signal processing device in the information processing apparatus 12 receives an input of the audio signal to when the virtual signal processing device outputs the audio signal may be longer than a second time from when the signal processing device in the audio signal processing apparatus receives an input of the audio signal to when the signal processing device outputs the audio signal. For example, during a live performance, the audio signal processing apparatus needs to process the audio signal in real time. However, offline simulation does not need to perform signal processing in real time. Therefore, the information processing apparatus 12 may simulate the signal processing device by lower signal processing capacity than the signal processing capacity of the audio signal processing apparatus to be simulated. In such a case, the information processing apparatus 12 is able to simulate offline the logic processor that operates by using the input of the audio signal as a trigger.

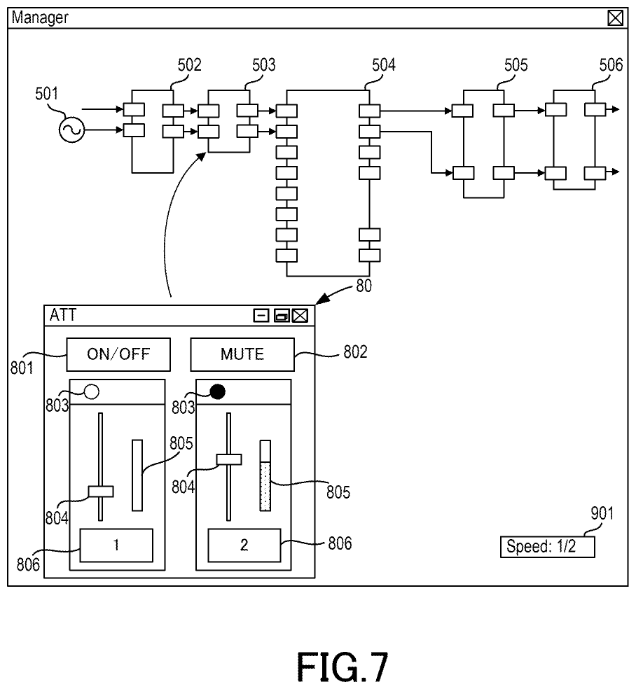

In addition, the information processing apparatus 12 may take information corresponding to a time difference between the second time and the first time, from a user. FIG. 7 is a view showing an example of a GUI that an editor 353 according to a modification presents. In the GUI shown in FIG. 7, the editor 353 further displays a speed designation icon 901. The speed designation icon 901 designates a ratio of a signal processing speed in the editor 353 to the signal processing speed of the audio signal processing apparatus to be simulated. In other words, the speed designation icon 901 is an example of the user I/F for taking the information corresponding to the time difference of the first time to the second time.

In this example, the editor 353 takes the ratio of the signal processing speed in the editor 353 to the signal processing speed of a real system as ½. Therefore, the first time from when the virtual signal processing device in the information processing apparatus 12 inputs the audio signal to when the virtual signal processing device outputs the audio signal is designated as twice the second time from when the signal processing device in the audio signal processing apparatus to be simulated inputs the audio signal to when the signal processing device outputs the audio signal. In short, the information processing apparatus 12 executes signal processing in twice the time of the real system.

As described above, a user may designate the speed of signal processing. The user, when not minding a slow operation, is able to reduce a processing load of the information processing apparatus 12 and execute signal processing at a low speed. As a matter of course, even in such a case, the information processing apparatus 12 is also able to simulate offline a logic processor that operates by using an input of the audio signal as a trigger.

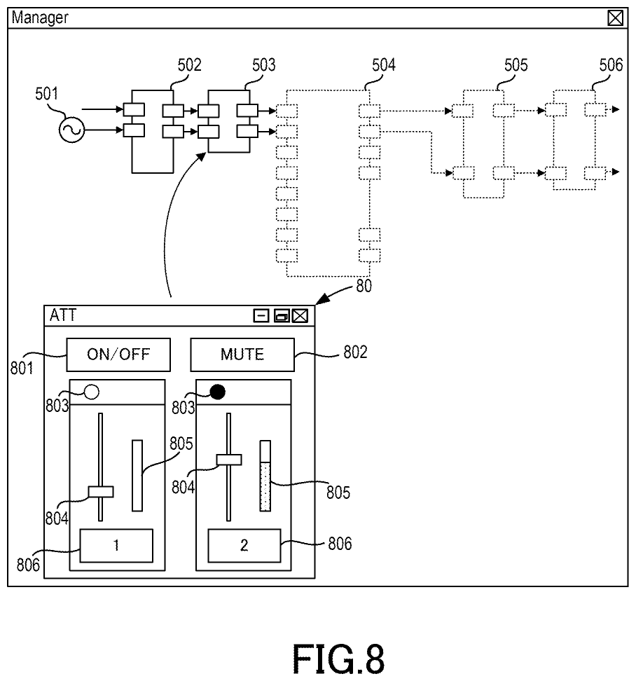

The information processing apparatus 12 may take designation of a virtual signal processing component that inputs the audio signal and performs the signal processing, among the plurality of virtual signal processing components, from a user. FIG. 8 is a view showing an example of a GUI that an editor 353 according to a second modification presents. In the GUI shown in FIG. 8, the editor 353 takes designation of a virtual signal processing component that performs signal processing. In the example of FIG. 8, the oscillator 501, the input component 502, and the attenuator 503 are designated. The mixing component 504, the amplifier 505, and the output component 506 are not designated.

The oscillator 501 outputs the audio signal. The input component 502 and the attenuator 503 perform signal processing. The signal processing ends at the attenuator 503, and the mixing component 504, the amplifier 505, and the output component 506 do not perform the signal processing.

As a result, the user can limit the range of the signal processing. The information processing apparatus 12, since limiting the range of the signal processing, is able to simulate the signal processing with a low load. Even in this case, the user, by inputting an audio signal to the logic processor of which the operation is desired to be checked, can simulate offline.

It is to be noted that the information processing apparatus 12 may record the audio signal on which the signal processing has been performed by the virtual signal processing component. In addition, the information processing apparatus 12, in a case of limiting the range of the signal processing as shown in FIG. 8, may record the audio signal on which the signal processing has been performed in a limited range. The user can check a simulation result of the signal processing device at any time by listening to a recorded audio signal. Moreover, the user can check the simulation result at any time, so that the information processing apparatus 12 does not need to perform the signal processing in real time. For example, the information processing apparatus 12 may execute the signal processing at a timing when a load on the CPU 303 is low.

The description of the foregoing embodiments is illustrative in all points and should not be construed to limit the present disclosure. The scope of the present disclosure is defined not by the foregoing embodiments but by the following claims for patent. Further, the scope of the present disclosure is intended to include all modifications within the scopes of the claims for patent and within the meanings and scopes of equivalents.

For example, the audio signal processing apparatus includes a power amplifier, a mixer, or an audio amplifier, for example, in addition to a processor. The information processing apparatus is also able to simulate signal processing to be executed not only by a processor but also by a power amplifier, a mixer, an audio amplifier, or a similar apparatus.

What is claimed is:

1. A signal processing simulation method comprising:
obtaining a designation of an audio signal processing apparatus that performs first signal processing on a first audio signal input to the audio signal processing apparatus;
obtaining a designation of a signal processing component;
obtaining settings of the designated signal processing component; and
constructing a virtual signal processing device having the designated signal processing component, the constructed virtual processing device corresponding to the designated audio signal processing apparatus, wherein:
the virtual signal processing device inputs a second audio signal to the designated signal processing component;
the designated signal processing component performs second signal processing, according to the obtained settings of the designated signal processing component, on the second audio signal that has been inputted to the designated signal processing component, and outputs the second audio signal on which the second signal processing has performed; and
the virtual signal processing device includes a logic processor that operates by using the second audio signal inputted to the designated signal processing component as a trigger.

2. The signal processing simulation method according to claim 1, wherein a sound corresponding to the second audio signal inputted to the designated signal processing component differs from a sound corresponding to the first audio signal inputted to the audio signal processing apparatus.

3. The signal processing simulation method according to claim 1, wherein a first time from when the virtual signal processing device receives an input of the second audio signal to when the virtual signal processing device outputs the second audio signal on which the second signal processing has performed is longer than a second time from when the designated audio signal processing apparatus receives an input of the first audio signal to when the designated audio signal processing apparatus outputs the first audio signal on which the first signal processing has been performed.

4. The signal processing simulation method according to claim 3, further comprising obtaining information corresponding to a time difference between the first time to the second time, from a user.

5. The signal processing simulation method according to claim 1, wherein the virtual signal processing device includes a plurality of designated signal processing components including a first designated signal processing component that receives an input of the second audio signal and performs the second signal processing, the plurality of designated signal processing components being less than all signal processing components included in the virtual signal processing device.

6. The signal processing simulation method according to claim 1, further comprising recording the second audio signal on which the second signal processing has been performed by the designated signal processing component.

7. A signal processing simulator comprising:
a memory configured to store instructions; and
a processor configured to execute the instructions stored in the memory to cause the signal processing simulator to:
obtain a designation of an audio signal processing apparatus that performs first signal processing on a first audio signal input to the audio signal processing apparatus;
obtain a designation of a signal processing component;
obtain settings of the designated signal processing component; and
construct a virtual signal processing device having the designated signal processing component, the constructed virtual processing device corresponding to the designated audio signal processing apparatus, wherein:
a second audio signal is input to the designated signal processing component;
the designated signal processing component performs second signal processing, according to the obtained settings of the designated signal processing component, on the second audio signal that has been inputted to the designated signal processing component, and outputs the second audio signal on which the second signal processing has performed; and
the virtual signal processing device includes a logic processor that operates by using the second audio signal inputted to the designated signal processing component as a trigger.

8. The signal processing simulator according to claim 7, wherein a sound corresponding to the second audio signal inputted to the designated signal processing component differs from a sound corresponding to the first audio signal inputted to the audio signal processing apparatus.

9. The signal processing simulator according to claim 7, wherein a first time from when the virtual signal processing device receives an input of the second audio signal to when the virtual signal processing device outputs the second audio signal on which the second signal processing has performed is longer than a second time from when the designated audio signal processing apparatus receives an input of the first audio signal to when the designated audio signal processing apparatus outputs the first audio signal on which the first signal processing has been performed.

10. The signal processing simulator according to claim 9, wherein the processor is configured to execute the instructions stored in the memory to further cause the signal processing simulator to obtain information corresponding to a time difference between the first time to the second time, from a user.

11. The signal processing simulator according to claim 7, wherein:
the virtual signal processing device includes a plurality of designated signal processing components including a first designated signal processing component that receives an input of the second audio signal and performs the second signal processing, the plurality of designated signal processing components being less than all signal processing components included in the virtual signal processing device.

12. The signal processing simulator according to claim 7, wherein the processor is configured to execute the instructions stored in the memory to further cause the signal processing simulator to record the second audio signal on which the second signal processing has performed by the designated signal processing component.
